(19) United States
(12) Patent Application Publication
(10) Pub. No.: US 2005/0050686 A1
(43) Pub. Date: Mar. 10, 2005

(54) Two-shaft hinge structure

(75) Inventor: Tomoyasu Kurokawa, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 10/877,207

(22) Filed: Jun. 25, 2004

(30) Foreign Application Priority Data
Jun. 30, 2003 (JP) 2003-187480

(51) Int. Cl. E05D 7/00

(52) U.S. Cl. 16/354

(57) ABSTRACT

A hinge structure coupling housing halves and of a device rotatably. The hinge structure comprises a first shaft fixed to the first housing half, a first gear provided on the first shaft, a second shaft fixed to the second housing half, and a second gear provided on the second shaft. The first gear meshes with the second gear such that the first and second gears rotate simultaneously in opposite directions. When the device is an image pickup device 1, its housing halves that have an image pickup unit and a display unit, respectively, are coupled rotatably through the hinge structure.

### BACKGROUND OF THE INVENTION

1. Field of the Invention

The present invention relates to hinge structures, and image pickup apparatus and portable electronic apparatus using the hinge structures.

2. Description of the Related Art

In the past, folding electronic apparatus such as, for example, cellular phones, PHSs (R), PDAs, note type PCs and digital cameras whose housing halves are connected by a hinge structure have been proposed and put to practical use.

In the past, some image pickup apparatus that employ a hinge structure by which one of its housing halves is connected through a rotating shaft to the other housing half have been proposed. Recently, two-shaft hinge structures having two rotating shafts have been proposed (for example, Japanese Patent Publication 2000-98470, page 3, FIG. 2).

When an image pickup apparatus or portable electronic apparatus employs a hinge structure having a single rotating shaft, one housing half thereof can be rotated relative to the other housing half. However, when the rotational angle reaches a predetermined value, adjacent ends of the two housing halves will obstruct each other, thereby making it impossible to cause one housing half to rotate through 360 degrees relative to the other.

On the other hand, when the image pickup apparatus or a portable electronic apparatus employs the prior art two-shaft hinge structure, one housing half of the apparatus can be rotated through 180 degrees in one direction around the first shaft while the other housing half is being rotated around the second shaft through 180 degrees in the other direction. Thus, as a result the one housing half can be rotated through 360 degrees relative to the other. Since the image pickup apparatus or portable electronic apparatus employing the prior art two-shaft hinge structure has a composition by which the two housing halves are rotated separately and independently around the respective shafts. Thus, complicated operation is required for rotating the two housing halves separately. Since the rotation of the respective housing halves change depending on the user's manner of operation thereof, opening and closing of the housing halves can often be unstable.

### SUMMARY OF THE INVENTION

In one preferable aspect, the present invention provides a hinge structure comprising:
a first shaft fixed to a first one of housing halves of a device;
a first gear provided on the first shaft;
a second shaft fixed to a second one of the housing halves; and
a second gear provided on the second shaft,
wherein the first gear meshes with the second gear such that the first and second shafts rotate simultaneously in opposite directions.

In another preferable aspect, the present invention provides an image pickup apparatus comprising:
a first shaft fixed to a first one of housing halves of the apparatus, the first housing half having an image pickup unit provided thereon;
a first gear provided on the first shaft;
a second shaft fixed to a second one of the housing halves, the second housing half having a display unit provided thereon; and
a second gear provided on the second shaft,
wherein the first gear meshes with the second gear such that the first and second shafts rotate simultaneously in opposite directions.

In still another preferable aspect, the present invention provides a portable electronic apparatus comprising:
a first shaft fixed to a first one of housing halves of the apparatus, the first housing half having a key-in unit provided thereon;
a first gear provided on the first shaft;
a second shaft fixed to a second one of housing halves of the apparatus, the second housing half having a display unit provided thereon; and
a second gear provided on the second shaft,
wherein the first gear meshes with the second gear such that the first and second shafts rotate simultaneously in opposite directions.

### BRIEF DESCRIPTION OF THE DRAWINGS

The accompanying drawings, which are incorporated in and constitute a part of the specification, illustrate presently preferred embodiments of the present invention and, together with the general description given above and the detailed description of the preferred embodiments given below, serve to explain the principles of the present invention in which:

FIG. 1 is a plan view of an image pickup apparatus (digital camera) of an embodiment 1 according to the present invention;

FIG. 2 is a perspective view of the digital camera of FIG. 1;

FIG. 3A is a perspective view of the digital camera of FIG. 1 in a portable state;

FIG. 3B is a perspective view of the digital camera of FIG. 3A in which a first and a second housing half are each rotated through 90 degrees;

FIG. 3C is a perspective view of the digital camera of FIG. 1 in an image pickup state;

FIG. 4A is a perspective view of a two-shaft hinge structure provided in the digital camera of FIG. 1;

FIG. 4B is an enlarged view of a part B of FIG. 4A;

FIG. 5 illustrates rotational angles of a first and a second gear of FIGS. 4A and 4B;

FIG. 6 illustrates rotation of the two-shaft hinge structure of FIGS. 4A and 4B;

FIG. 7A illustrates a gap provided between the first and second housing halves of the digital camera of FIG. 1;

FIG. 7B is an enlarged view of a part B of FIG. 7A;

FIG. 8A is a front view of a modification of the gears of the two-shaft hinge structure of the embodiment 1;

FIG. 8B is a side view of the modification of the gears of FIG. 8A;

FIG. 9A is a front view of a second modification of the two-shaft hinge structure of the first embodiment;

FIG. 9B is a side view of the second modification of the gears of FIG. 9A;

FIG. 10 illustrates rotation of an image pickup apparatus (digital camera) of an embodiment 2 of the present invention; and

FIG. 11 is a plan view of an image pickup apparatus (a cellular phone with a camera) as an embodiment 3 of the present invention.

### DETAILED DESCRIPTION

The same reference numerals are used to denote like parts in the accompanying drawings.

(Embodiment 1)

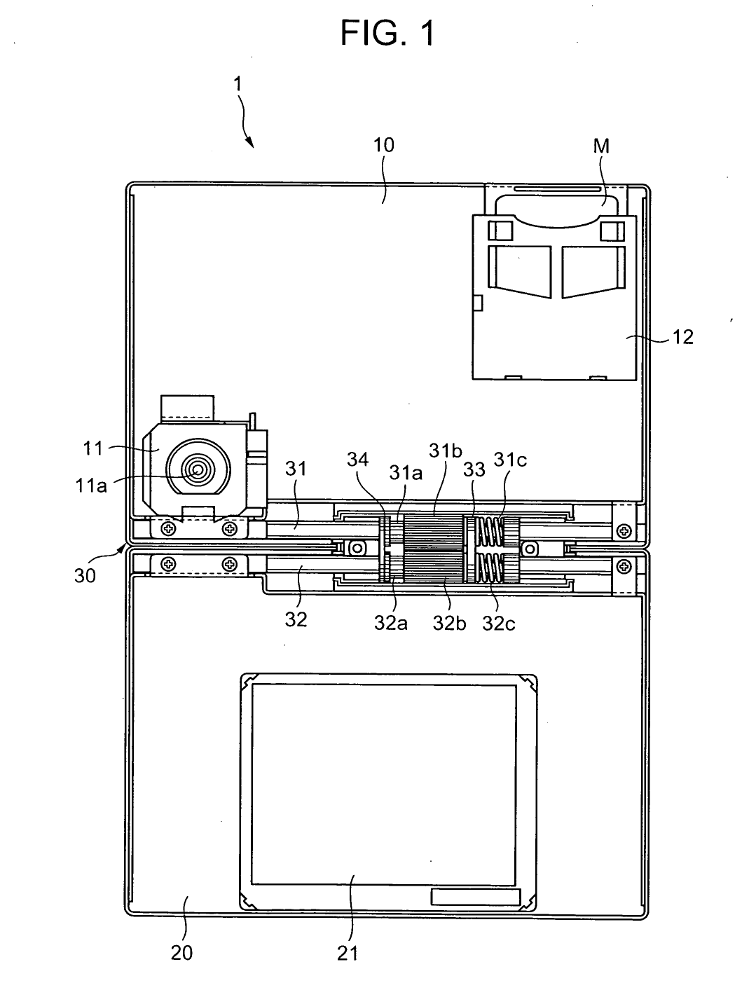

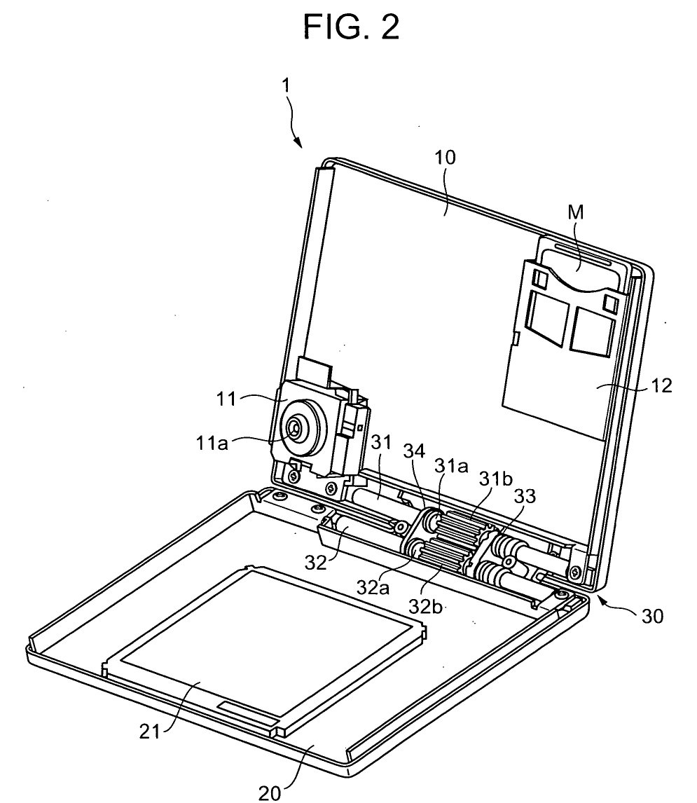

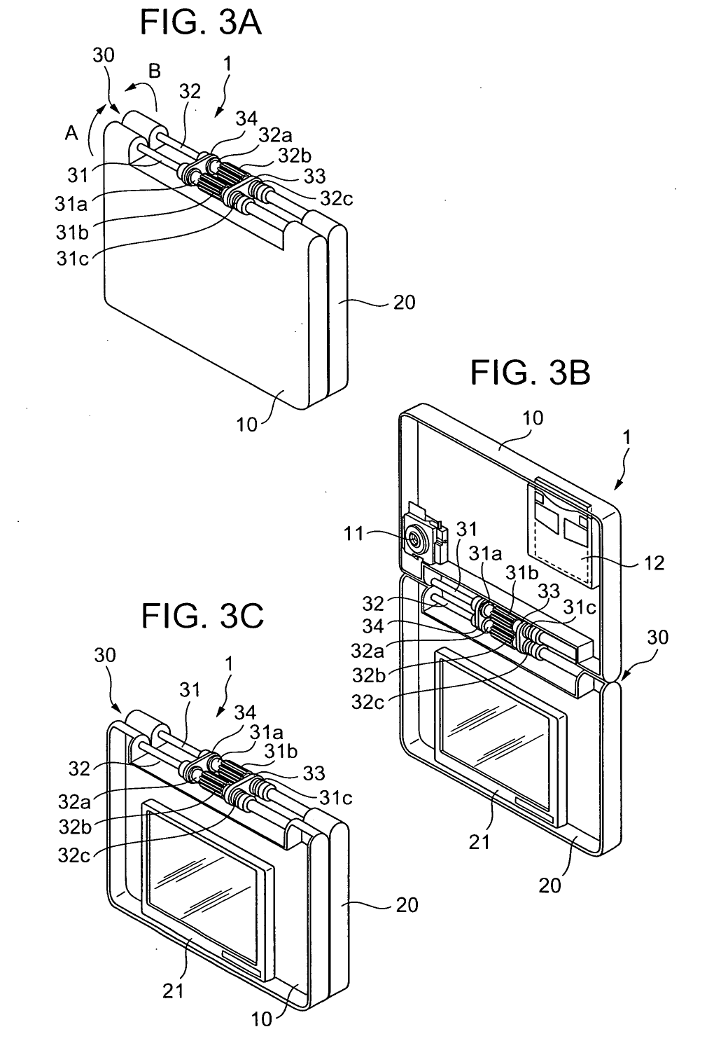

Referring to FIG. 1-3, the whole structure of a digital camera 1 as an embodiment 1 will be described. FIG. 1 is a plan view of the digital camera 1 in an open state. FIG. 2 is a perspective view of the digital camera 1 in the open state. FIG. 3A is a perspective view of the digital camera 1 in which the inner surface of a first housing half 10 thereof faces that of a second housing half 20 thereof in a close state (hereinafter referred to as a portable state). FIG. 3B is a perspective view of the digital camera 1 in which the first and second housing halves 10 and 20 are opened relative to each other from the portable state of FIG. 3A. FIG. 3C is a perspective view of the digital camera 1 in which the outer surfaces of the first and second housing halves 10 and 20 are put back to back with each other (this state is hereinafter referred to as an image pickup state).

The digital camera 1 has a two-shaft hinge structure 30 that couples the first and second housing halves 10 and 20 rotatably. The components of the camera 1 housed within the first and second housing halves10 and 20 are connected electrically by a FPC cable (not shown) to each other.

As shown in FIGS. 1and 2, the first housing half 10 has substantially a thin parallelepiped body of a metal material such as aluminum or stainless steel. The first housing half 10 has an image pickup unit 11 including a lens 11a and a CCD (not shown), a card slot unit 12 that receives a memory card M on which acquired image information and other data are recorded, a strobe (not shown) that illumines an object with light in a dark place for image pickup purpose, a self timer lamp (not shown) for reporting an image pickup timing to the user when automatic image pickup is to be performed, and a control unit (not shown) for controlling the whole digital camera 1. The lens 11a of the image pickup unit 11 is positioned on the image pickup unit 11 such that its front appears when the first and second housing halves 10 and 20 are opened.

The control unit comprises a CPU that controls the whole digital camera 1, a ROM that has stored various control programs, a RAM that comprises a work area on which image information is temporarily stored and which a control program is temporarily developed. The control unit is connected electrically to the image pickup unit 11 and the card slot unit 12. The control unit is connected through the FPC cable to the display unit 21 and the operation unit of the second housing half 20. When the control unit receives an operation signal from the operation unit, it controls the image pickup unit 11 to perform predetermined image pickup operation.

As shown in FIGS. 1 and 2, the second housing half 20 also has a thin parallelepiped body of a metal material such as aluminum or stainless steel. The second housing half 20 has a display unit 21 that displays a still image of an object and an animation image, the operation unit (not shown) that comprises a shutter key (not shown) for image pickup purpose and function keys (not shown) to select a mode, and a finder eye piece (not shown). As described above, the display unit 21 and the operation unit are electrically connected by the FPC cable to the control unit of the first housing half 10 and controlled by the control unit, as described above.

The two-shaft hinge structure 30 comprises a first shaft 31 fixed to the first housing half 10 along an edge of the first housing half 10, a first gear 31b provided on the outer periphery of the first shaft 31, a second shaft 32 fixed to the second housing half 20 along an edge of the second housing half 20 parallel to the first shaft 31, a second gear 32b provided on the outer periphery of the second shaft 32 and meshing with the first gear 31b, and a first ring 33 and a second ring 34 that support the first and second shafts 31 and 32, respectively, in a rotatable state.

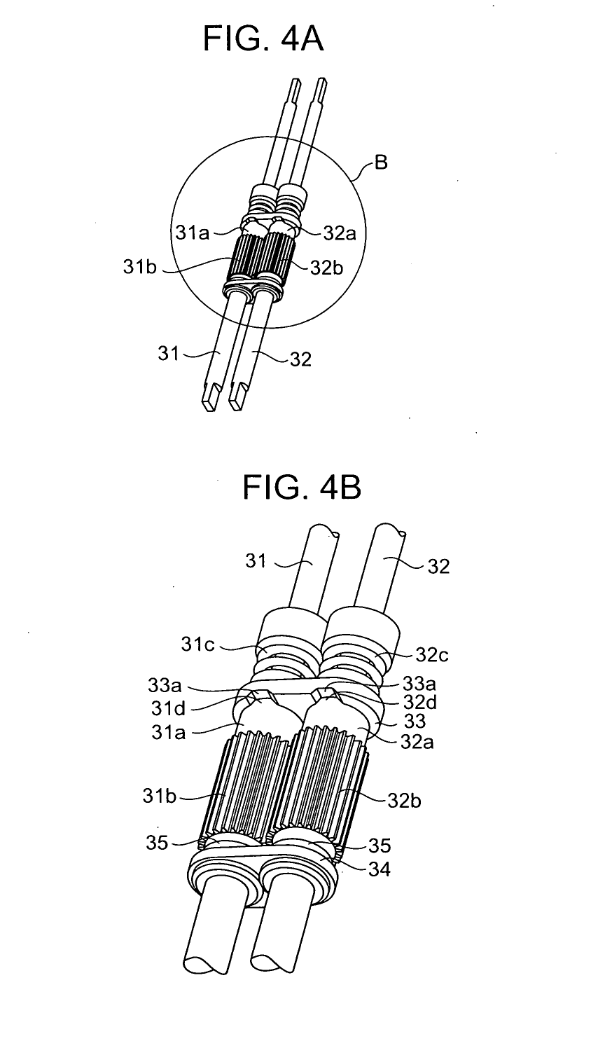

The first and second gears 31b and 32b fixed to the outer peripheries of the first and second shafts 31 and 32 are arranged to rotate through the same angle in opposite directions. The details of the structure of the two-shaft hinge structure 30 will be described with reference to FIGS. 4-7 later.

When an external force acts on the digital camera 1 in the portable state (FIG. 3A) so as to separate the first and second housing halves 10 and 20 in the opposite directions shown by arrows A and B, the first and second gears 31b and 32b of the two-shaft hinge structure 30 rotate by the same angle in the opposite directions. As a result, the first and second housing halves 10 and 20 fixed to the first and second gears 31a and 32a, respectively, rotate through the same angle in the opposite directions.

FIG. 3B illustrates that the first and second housing halves 10 and 20 (the first and second gears 31a and 32a) have rotated through 90 degrees in the directions of arrows A and B, respectively, from the state of FIG. 3A. FIG. 3C illustrates that the first and second housing halves 10 and 20 (the first and second gears 31a and 32a) have rotated through 180 degrees in the directions of arrows A and B, respectively, from the state of FIG. 3A.

When the digital camera 1 is in the portable state, the inner surfaces of the first and second housing halves 10 and 20 are close to each other such that the image pickup unit 11 and the display unit 21 are hidden within the digital camera 1 (FIG. 3A). When the digital camera 1 picks up an image of an object, the first and second housing halves 10 and 20 are turned over through the hinge structure 30 such the image pickup unit 11 and the display unit 21 are exposed outside (FIG. 3C).

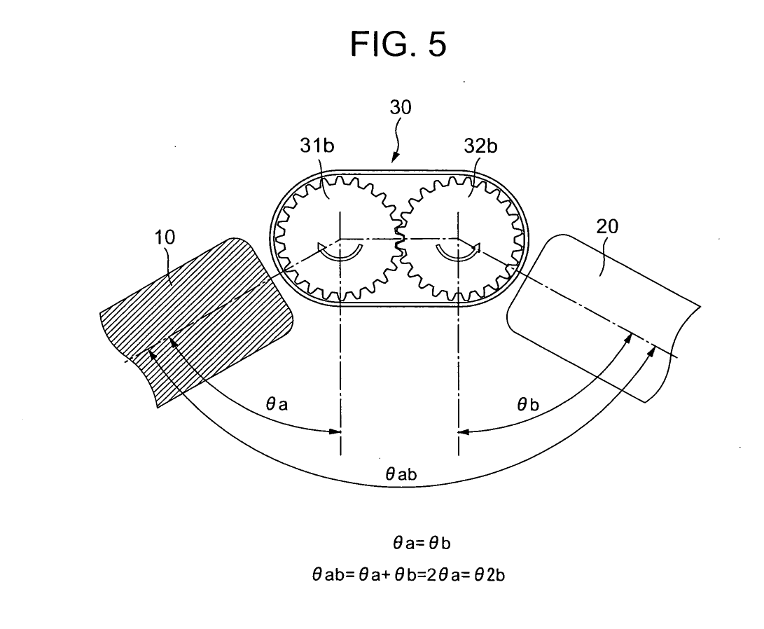

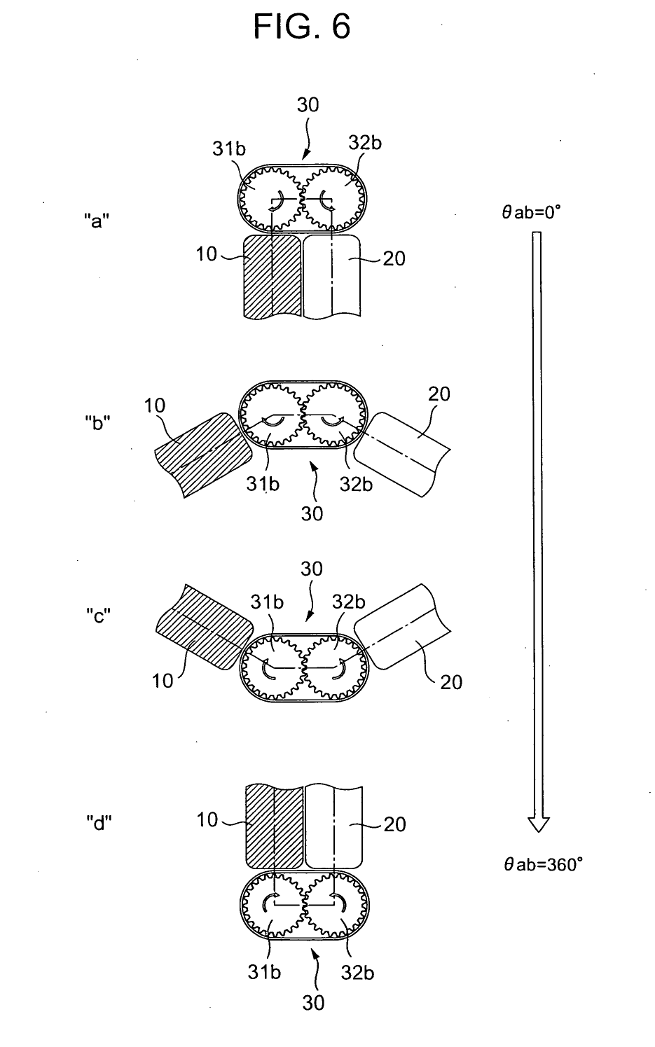

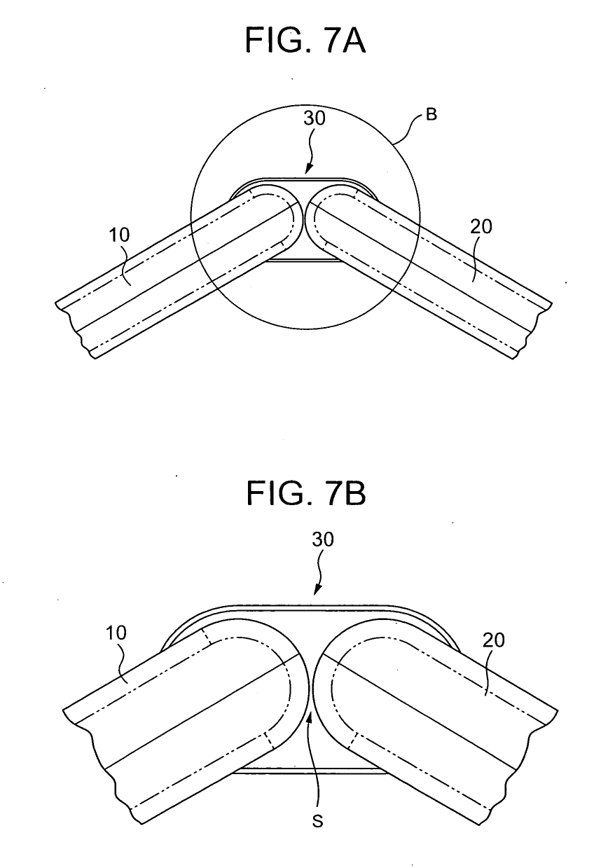

Next, referring to FIGS. 4-7, the composition of the two-shaft hinge structure 30 of the digital camera 1 will be described in detail. FIG. 4A is a perspective view of the two-shaft hinge structure 30. FIG. 4B is an enlarged view of a part B of FIG. 4A. FIG. 5 illustrates rotational angles of the first and second gears 31a and 32a. FIG. 6 illustrates operation of the two-shaft hinge structure 30. FIG. 7A illustrates a gap provided between the first and second housing halves 10 and 20. FIG. 7B is an enlarged view of a part B of FIG. 7A.

The first gear 31b comprises a first spur gear provided on a first cylinder 31a composing a middle portion of the length of the first shaft 31 (FIG. 4A). The first cylinder 31a and the first gear 31b rotate together with the first shaft 31. A first and a second ring 33 and 34 that support the first and second shafts 31 and 32 rotatably abut on the opposite ends of the first cylinder 31a (FIG. 4B). The first ring 33, the first cylinder 31a and the first gear 31b are always pressed against the second ring 34 by a first coil spring 31c fitted over the first shaft 31 (FIG. 4B).

The second gear 32b comprises a spur gear provided on a second cylinder 32a composing a middle portion of the length of the second shaft 32 (FIG. 4A). The second cylinder 32a and the second gear 32b rotate together with the second shaft 32. The first and second rings 33 and 34 rotatably abut on the opposite ends of the second cylinder 32a. The first ring 33, the second cylinder 32a and the second gear 32b are always pressed against the second ring 34 by a second coil spring 32c fitted over the second shaft 32 (FIG. 4B).

The first and second cylinders 31a and 32a have axial protrusions 31d and 32d provided on the peripheries of the first ring 33 side ends, respectively, thereof. The first ring 33 has recesses 33a provided on its end on the sides of the first and second cylinders 31a and 32a and receiving the protrusions 31d and 32d. As shown in FIG. 4B, the recesses 33a have relatively easy slopes. Thus, when the protrusions 31d and 32d of the first and second cylinders 31a and 32a reach near the slopes of the first ring recesses 33a, the protrusions 31d and 32d move into the recesses 33a as if they were sucked into the respective recesses.

More particularly, the number of axial protrusions 31d provided on the periphery of the end of the first cylinder 31a is two. Each time the first cylinder 31a rotates through 180 degrees, the protrusions 31d are fitted into the respective recesses 33a in the first ring 33. Likewise, the number of axial protrusions 32d provided on the periphery of the end of the second cylinder 32a is two. Each time the second cylinder 32a rotates through 180 degrees, the protrusions 32d are fitted into the respective recesses 33a in the first ring 33. The numbers of first and second cylinder protrusions 31d and 32d are not especially limitative in the present invention.

As described above, when the first cylinder protrusions 31d are fitted into the first ring recesses 33a, rotation of the first shaft 31 and the first housing half 10 fixed to the first shaft 31 is temporarily restricted. Likewise, when the second cylinder protrusions 32d are fitted into the second ring recesses 33a, rotation of the second shaft 32 and the second housing half 20 fixed to the second shaft 32 is temporarily restricted. The first cylinder protrusions 31d, the second cylinder protrusions 32d and the first ring recesses 33a compose a rotation restricting mechanism in the present invention.

A clicking ring 35 is fixed in a fitted state to the second ring 34 side end of each of the first and second cylinders 31a and 32a. The clicking ring 35 has axial protrusions (not shown) on a periphery of an end thereof protruding toward the second ring 34. The second ring 34 has recesses provided on an end thereof on the sides of the first and second cylinders 31a 32a thereof for receiving the clicking ring 35 protrusions in a fitted/engaged state.

The number of axial protrusions provided on the periphery of the end of each of the clicking rings 35 is four. The number of axial recesses provided on the periphery of the end of the second ring 34 is eight (four on the side of each of the first cylinders 31a and 32a). Thus, each time the respective first and second cylinders 31a and 32a rotate through 90 degrees, the protrusions will be fitted and engaged in the recesses provided on the second ring 34 (clicking is performed). The number of axial protrusions provided on the clicking ring 35 and the number of axial recesses provided on the second ring 34 are not especially limitative in the present invention.

As described above, when the clicking ring 35 protrusions are fitted and engaged in the recesses on the second ring 34, rotation of the first shaft 31 and the first housing half 10 fixed to the first shaft 31 is temporarily restricted as well as rotation of the second shaft 32 and the second housing half 20 fixed to the second shaft 32 is temporarily restricted. The clicking ring 35 protrusions and the second ring 34 recesses compose a rotation restricting mechanism in the present invention.

In the embodiment, the first and second gears 31b and 32b provided respectively on the first and second shafts 31 and 32 have the same number of teeth and the same pitch (or gap between teeth) (FIG. 5). Thus, the first and second gears 31b and 32b rotate through the same angle in opposite directions. Let the rotational angles of the first and second gears 31b and 32b of the two-shaft hinge structure from their reference positions that are the positions of the first and second gears 31b and 32b in the portable state (FIG. 3A) be θₐ and θ_{b}, respectively. Then, θₐ=θ_{b} (FIG. 5).

The rotational angles θₐ and θ_{b} of the first and second gears 31b and 32b are equal to those of the first and second housing halves 10 and 20, respectively. Thus, let an angle between the first and second housing halves 10 and 20 be θ_{ab}. Thus, θ_{ab}=θₐ+θ_{b}=2θₐ=2θ_{b}(FIG. 5). The angle θ_{ab} between the first and second housing halves 10 and 20 can vary through 0-360 degrees (“a”-“d” of FIG. 6). The FIG. 6 “a” state corresponds to that of FIG. 3A. The FIG. 6 “d” state corresponds to that of FIG. 3C.

In the two-shaft hinge structure 30 of this digital camera 1, the first and second gears 31b and 32b provided on the first and second shafts 31 and 32 fixed to the first and second housing halves 10 and 20, respectively, are arranged to rotate simultaneously in opposite directions (FIGS. 5 and 6). Thus, the first and second housing halves 10 and 20 can be rotated simultaneously in opposite directions around the first and second shafts 31b and 32b, respectively.

Thus, complicated operation to rotate the first and second housing halves 10 and 20 separately is not required. That is, the two housing halves can be rotated simultaneously in very simple operation. In addition, the first housing half 10 can be rotated through 360 degrees relative to the second housing half 20. Since the first and second housing halves 10 and 20 rotate in conjunction with each other, the opening/closing operation of the housing is stabilized.

In this two-shaft hinge structure 30, since the first and second gears 31b and 32b have the same number of teeth and the same pitch, the first and second housing halves 10 and 20 can be rotated through the same angle in opposite directions (FIG. 5).

In this two-shaft hinge structure 30, the rotation restricting mechanism (comprising the first cylinder protrusions 31d, the second cylinder protrusions 32d, the first ring recesses 33a, the clicking ring 35 protrusions, and the second ring 34 recesses) can temporarily restrict the rotation of the first and second gears 31b and 32b at intervals of a predetermined angle. Thus, rotation of the first and second housing halves 10 and 20 can be restricted temporarily at intervals of a predetermined angle θ_{ab} (for example, of 0, 180 or 360 degrees).

In this digital camera, the first and second housing halves 10 and 20 that have the image pickup unit 11 and the display 21, respectively, are connected through the two-shaft hinge structure 30 (FIGS. 1 and 2). Thus, the two housing halves 10 and 20 can be rotated through the two-shaft hinge structure 30 such that the inner surfaces of the first and second housing halves 10 and 20 on which the image pickup unit 11 and the display unit 21 are provided, respectively, face each other in a close state (FIG. 3A). Thus, the image pickup unit 11 and the display unit 21 are protected from being damaged. By rotating the two housing halves 10 and 20 through the hinge structure 30 through 180 degrees in opposite directions, the image pickup unit 11 and the display unit 21 can be exposed back to back with each other so as to face in opposite directions (FIG. 3B). Thus, the image pickup unit 11 and the display unit 21 can be used for image pickup purpose.

The space between the first and second shafts 31 and 32 as the centers of rotation of the first and second housing halves 10 and 20 will not fluctuate. In addition, a gap S is provided between the adjacent ends of the first and second housing halves 10 and 20 (FIGS. 7A and 7B). Thus, even when the two housing halves 10 and 20 are rotated in opposite directions through the two-shaft hinge structure 30, the adjacent ends of the two housing halves do not obstruct each other.

While in the embodiment the first and second spur gears 31b and 32b of the two-shaft hinge structure 30 are illustrated as directly meshing with each other to rotate themselves simultaneously in opposite directions, the present invention is not limited to such specified structure.

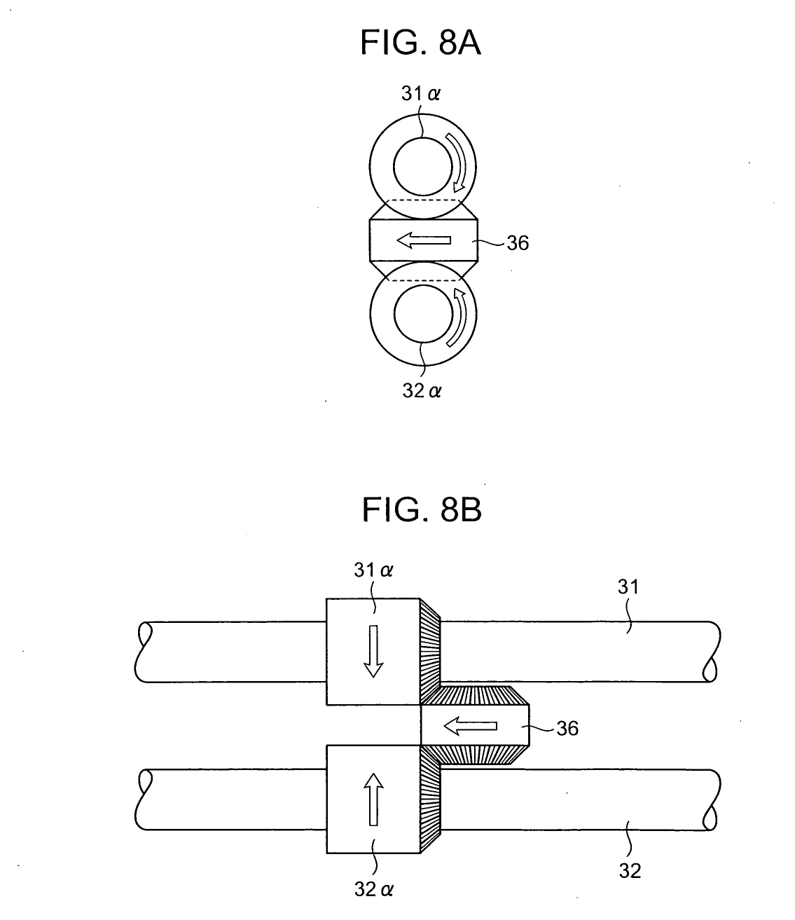

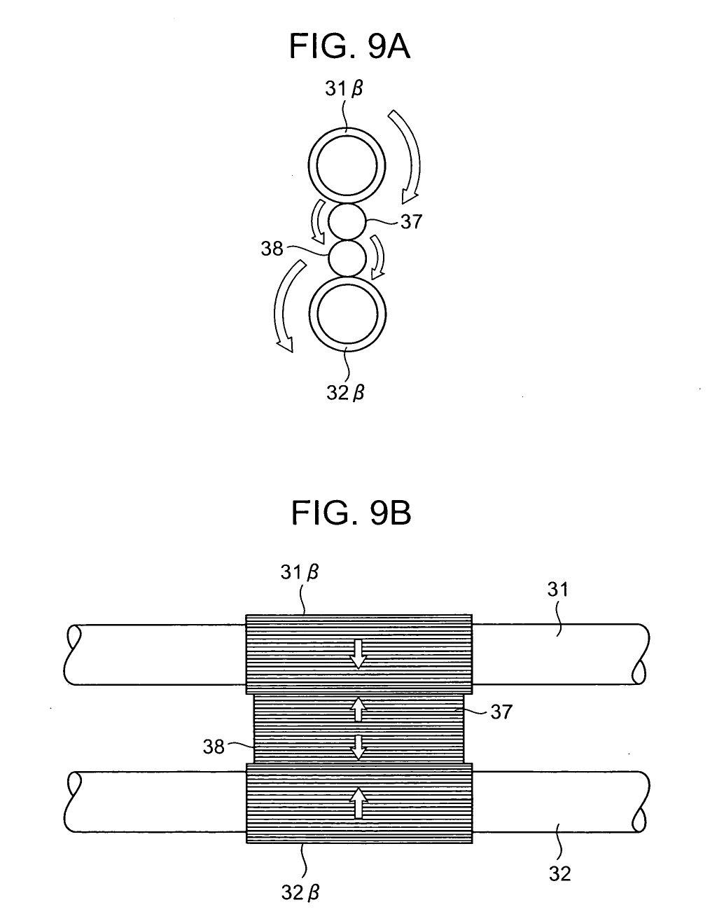

For example, as shown in FIGS. 8A and 8B the digital camera may comprise an arrangement in which an intermediate bevel gear 36 is provided between, and in meshing relationship to, a first and a second bevel gear 31α and 32α that are in turn provided on the first and second parallel shafts 31 and 32, respectively, to thereby rotate the first and second gears 31α and 32α simultaneously in opposite directions; Alternatively, as shown in FIGS. 9A and 9B, two intermediate meshing spur gears 37 and 38 may be provided between, and in meshing relationship to, a first and a second spur 0gear 31β and 32β so as to rotate the first and second gears 31β and 32β simultaneously in opposite directions.

By employing the arrangements of FIGS. 8A and 8B and 9A and 9B, the outer diameters of the first and second gears 31α, 31β and 32α, 32β are reduced. Thus, a space that houses the two-shaft hinge structure 30 is reduced.

(Embodiment 2)

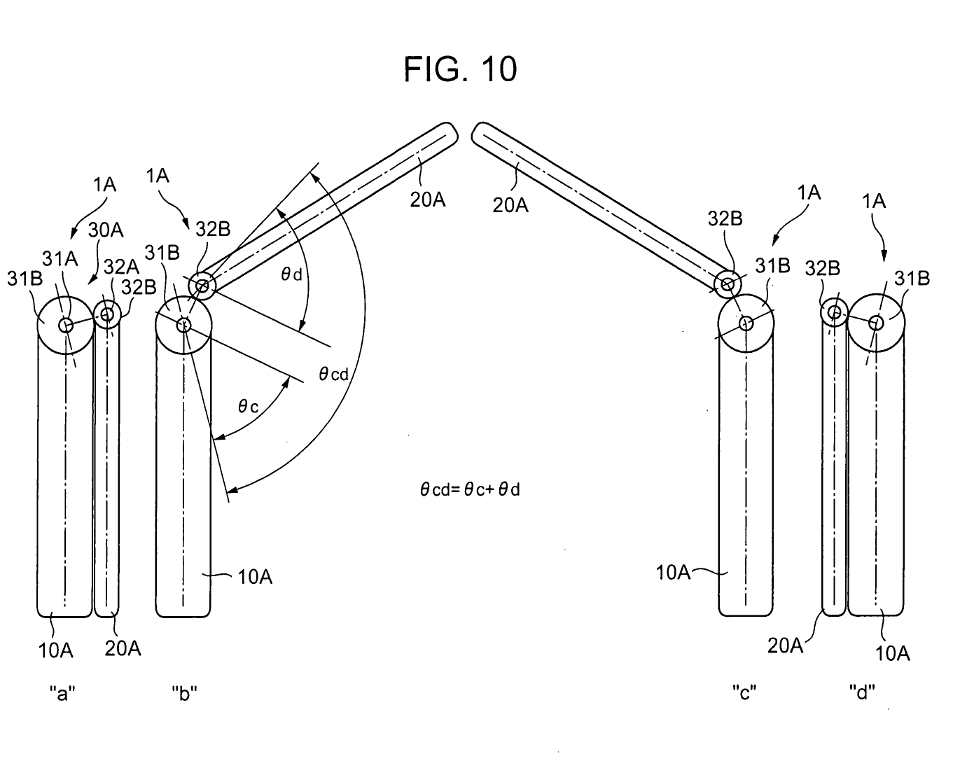

A digital camera 1A of an embodiment 2 will be described with reference to FIG. 10, which illustrates rotation of the housing halves of the camera. The digital camera 1A of this embodiment has the same structure as the digital camera 1 of the first embodiment excluding that the digital camera 1A is different in thickness, gear diameter and number of gear teeth from the camera 1, and further description thereof will be omitted.

As shown in FIG. 10A, the digital camera 1A has a two-shaft hinge structure 30A that rotatably couples a first and a second housing half 10A and 20A that have an image pickup unit and a display unit, respectively. In the digital camera 1A the first housing half 10A has three times the thickness of the second housing half 20A (“a” of FIG. 10).

The two-shaft hinge structure 30A comprises a first shaft 31A fixed to the first housing half 10A along an edge of the first housing half 10A, a first gear 31B provided on the outer periphery of the first shaft 31A, a second shaft 32A fixed to the second housing half 20A along an edge of the second housing half 20A parallel to the first shaft 31A, and a second gear 32B provided on the outer periphery of the second shaft 32A and meshing with the first gear 31B. The first gear 31B has approximately twice the diameter of the second gear 32B (“a” of FIG. 10). The first gear 31B also has approximately twice the number of teeth of the second gear 32B. Thus, a rotational angle θ_{c} of the first gear 31B is approximately half of the rotational angle θ_{d} of the second gear 32B.

The rotational angles θ_{c} and θ_{d} of the first and second gears 31B and 32B are equal to those of the first and second housing halves 10A and 20B, respectively. Let an angle between the first and second housing halves 10A and 20A be θ_{cd}. Then, θ_{cd}=θ_{c}+θ_{d} (“b” in FIG. 10). The angle θ_{cd} between the first and second housing halves 10A and 20A can vary through 0-360 degrees (“a”-“d” of FIG. 10).

In the two-shaft hinge structure 30A of this digital camera 1A, the first and second gears 31B and 32B provided on the first and second shafts 31A and 32A fixed to the first and second housing halves 10A and 20A, respectively, are arranged to rotate simultaneously in opposite directions. Thus, the first and second housing halves 10A and 20A can be rotated simultaneously in opposite directions around the first and second shafts 31B and 32B, respectively.

Thus, complicated operation to rotate the first and second housing halves 10A and 20A separately is not required. That is, the two housing halves can be rotated simultaneously in very simple operation. In addition, the first housing half 10A can be rotated through 360 degrees relative to the second housing half 20A (“a”-“d” in FIG. 10). Since the first and second housing halves 10A and 20A rotate in conjunction with each other, the opening/closing operation of the housing is stabilized.

In this two-shaft hinge structure 30, since the first and second gears 31b and 32b have the same number of teeth and the same pitch, the first and second housing halves 10 and 20 can be rotated through the same angle in opposite directions.

In this two-shaft hinge structure 30A, the two gears (first and second gears 31B and 32B) are different in diameter and number of teeth such that the housing halves (10A and 20A) different in thickness can be employed. Thus, a limitation to the thicknesses of the housing halves is eliminated to thereby improve the flexibility of design.

(Embodiment 3)

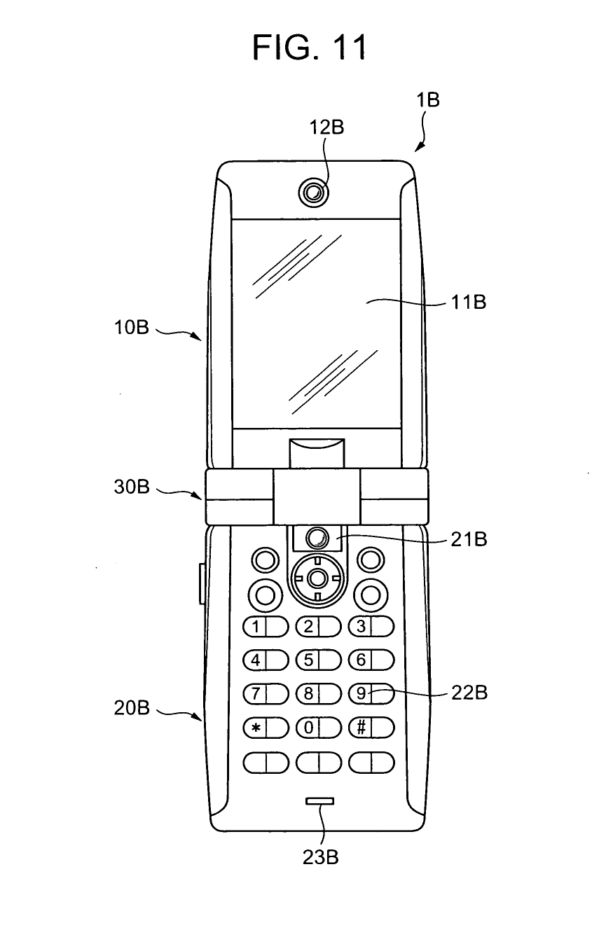

Next, referring to FIG. 11, which is a plan view of the cellular phone 1B in an open state, a third embodiment of the present invention directed to a folding electronic apparatus and more particularly a folding cellular phone 1B with a camera having a two-shaft hinge structure 30B will be described.

The cellular phone 1B has a two-shaft hinge structure 30B that rotatably couples the first and second housing halves 10B and 20B that have a display unit 11B and an image pickup unit 21B, an operation unit 22B, respectively. The components of the cellular phone 1B housed within the first and second housing halves 10B and 20B are connected electrically by an FPC cable (not shown) to each other.

More particularly, the first housing half 10B has the display unit 11B that displays still images and an animation of an object, and a speaker 12B. The second housing half 20B has the image pickup unit 21B composed of a lens and a CCD, the operation unit 22B composed of a cross key and alphanumerical keys, a microphone 23B and a control unit (not shown) that controls the whole cellular phone 1B. The control unit is connected electrically to the image pickup unit 21B and the operation unit 22B. The control unit is connected electrically to the display unit 11B of the first housing half 10B through a FPC cable.

The two-shaft hinge structure 30B comprises a first gear provided on a first shaft that is in turn provided on the first housing half 10B, a second gear provided on a second shaft that is in turn provided on the second housing half 20B and meshing with the first gear, and a rotation restricting mechanism. The two-shaft hinge structure 30B is substantially the same in composition as the two-shaft hinge structure 30 (FIGS. 1-6) of the first embodiment.

In this two-shaft hinge structure 30B, the first and second gears provided on the first and second shafts of the second and first housing halves 10B and 20B, respectively, are arranged to rotate simultaneously in opposite directions. Thus, the first and second housing halves 10B and 20B can be rotated in opposite directions around the first and second shafts, respectively.

Thus, a complicated structure to rotate the first and second housing halves 10B and 20B separately is not required and the two housing halves can be rotated simultaneously in a very simple manner such that the first housing half 10B is rotated through 360 degrees relative to the second housing half 20B. Since the first and second housing halves 10B and 20B are rotated in conjunction with each other, the opening/closing operation of the housing is stabilized.

In this two-shaft hinge structure 30B, the first and second gears have the same number of teeth and the same pitch. Thus, the first and second housing halves 10B and 20B can be rotated through the same angle in opposite directions.

In this two-shaft hinge structure 30B, the rotation restricting mechanism temporarily restricts rotation of the first and second gears and hence the first and second housing halves 10B and 20B in intervals of a predetermined rotational angle (for example, of 0, 180 or 360 degrees).

In this digital camera 1B, the first and second housing halves 10B and 20B that have the display unit 11B and the image pickup unit 21B, respectively, are connected through the two-shaft hinge structure 30B. Thus, the two housing halves 10B and 20B can be rotated through the two-shaft hinge structure 30B such that the inner surfaces of the first and second housing halves 10B and 20B on which the display unit 11B and the image pickup unit 21B are provided, respectively, face each other in a close state. Thus, the display unit 11B and the image pickup unit 21B are protected from being damaged. By rotating the two housing halves 10B and 20B through the hinge structure 30B through 180 degrees in opposite directions, the display unit 11B and the image pickup unit 21B can be exposed back to back with each other so as to face in opposite directions. Thus, the display unit 11B and the image pickup unit 21B can be used for image pickup purpose.

While in the above respective embodiments the folding digital cameras 1 and 1A and the folding cellular phone 1B with a camera in which the first and second housing halves are coupled rotatably through the two-shaft hinge structure are illustrated, the present invention is applicable to other folding image pickup apparatus (for example, folding PHSs (R) with a camera and folding PDAs with a camera) having structures similar to those of the digital cameras 1 and 1A, and the cellular phone 1B with a camera.

Various modifications and changes may be made thereunto without departing from the broad spirit and scope of this invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2003-187480 filed on Jun. 30, 2003 and each including specification, claims, drawings and summary. The disclosure of the above Japanese patent application is incorporated herein by reference in its entirety.

1. A hinge structure comprising:
a first shaft fixed to a first one of housing halves of a device;
a first gear provided on the first shaft;
a second shaft fixed to a second one of the housing halves; and
a second gear provided on the second shaft,
wherein the first gear meshes with the second gear such that the first and second shafts rotate simultaneously in opposite directions.

2. The hinge structure of claim 1, wherein the first gear meshes directly with the second gear.

3. The hinge structure of claim 1, further comprising a third gear meshing with and between the first and second gears.

4. The hinge structure of claim 1, further comprising a
support that supports the first and second shafts rotatably.

5. The hinge structure of claim 1, further comprising a
rotation restricting mechanism that gives a user a feeling of clicking each time the first and second shafts rotate through a predetermined angle.

6. The hinge structure of claim 1, wherein the first gear has the same number of teeth and the same pitch as the second gear.

7. The hinge structure of claim 1, wherein the first gear has the same pitch as, but a different number of teeth from, the second gear.

8. An image pickup apparatus comprising:
a first shaft fixed to a first one of housing halves of the apparatus, the first housing half having an image pickup unit provided thereon;
a first gear provided on the first shaft;
a second shaft fixed to a second one of the housing halves, the second housing half having a display unit provided thereon; and
a second gear provided on the second shaft,
wherein the first gear meshes with the second gear such that the first and second shafts rotate simultaneously in opposite directions.

9. The image pickup apparatus of claim 8, wherein the first gear meshes directly with the second gear.

10. The image pickup apparatus of claim 8, further
comprising a third gear meshing with and between the first and second gears.

11. The image pickup apparatus of claim 8, further
comprising a support that supports the first and second shafts rotatably.

12. The image pickup apparatus of claim 8, further
comprising a rotation restricting mechanism that gives a user a feeling of clicking each time the first and second shafts rotate through a predetermined angle.

13. The image pickup apparatus of claim 8, wherein the first gear has the same number of teeth and the same pitch as the second gear.

14. The image pickup apparatus of claim 8, wherein the first gear has the same pitch as, but a different number of teeth from, the second gear.

15. The image pickup apparatus of claim 8, wherein the first and the second housing halves are rotatable through 360 degrees relative to each other such that the image pickup unit and the display unit are exposed on opposite outer surfaces of, or hidden inside by, the first and second housing halves.

16. A portable electronic apparatus comprising:
a first shaft fixed to a first one of housing halves of the apparatus, the first housing half having a key-in unit provided thereon;
a first gear provided on the first shaft;
a second shaft fixed to a second one of housing halves of the apparatus, the second housing half having a display unit provided thereon; and
a second gear provided on the second shaft,
wherein the first gear meshes with the second gear such that the first and second shafts rotate simultaneously in opposite directions.

17. The portable electronic apparatus of claim 16, wherein the first gear meshes directly with the second gear.

18. The portable electronic apparatus of claim 16, further comprising a third gear meshing with and between the first and second gears.

19. The portable electronic apparatus of claim 16, further comprising a support that supports the first and second shafts rotatably.

20. The portable electronic apparatus of claim 16, further comprising a rotation restricting mechanism that gives a user a feeling of clicking each time the first and second shafts rotate through a predetermined angle.

21. The portable electronic apparatus of claim 16, wherein the first gear has the same number of teeth and the same pitch as the second gear.

22. The portable electronic apparatus of claim 16, wherein the first gear has the same pitch as, but a different number of teeth from, the second gear.

23. The portable electronic apparatus of claim 16, wherein the first and the second housing halves are rotatable through 360 degrees relative to each other such that the key-in unit and the display unit are exposed on opposite outer surfaces of, hidden inside by, the first and second housing halves.
